(19) United States
(12) Patent Application Publication
(10) Pub. No.: US 2010/0275526 A1
(43) Pub. Date: Nov. 4, 2010

(54) BUILDING-ABOVE-LAND FOR PROTECTION OF VEGETATION AND ENVIRONMENT

(76) Inventor: Yijing Sun, Dublin, OH (US)

Correspondence Address: Ingenium Patents LLC, 7 High Street, Terryville, CT, 06786, US

(21) Appl. No.: 12/835,095

(22) Filed: Jul. 13, 2010

Related U.S. Application Data
(63) Continuation-in-part of application No. 11/484,515, filed on Jul. 11, 2006, now abandoned.

(51) Int. Cl. E04B 1/34; E04B 1/35; E04B 7/04; A01G 9/14

(52) U.S. Cl. 52/93.1; 52/745.05; 52/173.1

(57) ABSTRACT

The disclosure describes novel eco-friendly buildings and methods of building eco-friendly structures. Buildings constructed above land permit vegetation to grow below. Buildings which incorporate greenhouses are also described.

### CROSS-REFERENCE TO RELATED APPLICATIONS

This application is a Continuation-In-Part of U.S. Nonprovisional application Ser. No. 11/484,515 filed Jul. 11, 2006. The contents of U.S. Ser. No. 11/484,515 are expressly incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates generally to the field of construction and specifically to the field of eco-friendly building construction.

2. Description of Related Art

In the related art, buildings have been constructed on foundations, such as in-ground basements, or other foundations which cover the ground surface and obliterate vegetation. Because of urbanization, especially since the 20^{th} century, the construction of architectural structures on ground has caused substantial environmental and ecological damage. Construction of buildings on land, i.e., buildings having “ground floors”, in urban and suburban areas is responsible for other detrimental effects, such as creation of vast regions of urbanization so aesthetically unpleasant that quality of life for the inhabitants is severely impacted. Methods have been practiced to allow improved coexistence of buildings and vegetation in urban as well as suburban areas; the methods include construction of rooftop gardens and garden areas located at various stories within high-rise buildings. None of these approaches can preserve or restore the land upon which buildings are constructed.

### BRIEF SUMMARY OF THE INVENTION

The invention is concerned with building houses above land in order to minimize environmental impact of building construction in urban and suburban areas. For the purpose of clarity, the term “urban” is defined and used according to the US Census 2000 Urban and Rural Classification. Several embodiments are disclosed. Some of these embodiments include a house built on high columns above land and vegetation, a house built above a greenhouse, a split-level above land design wherein the house is supported by low and high columns, and an elevated A-frame house supported by beams. Both the split-level and A-frame houses can be built above greenhouses.

### BRIEF DESCRIPTION OF THE SEVERAL VIEWS OF THE DRAWING(S)

The invention will now be described in more detail with reference to exemplifying embodiments thereof illustrated in drawings.

FIG. 1A and FIG. 1B are a perspective view and a side view of a building above land with high columns supporting it above short vegetation.

FIGS. 1C, 1D, and 1E are perspective views of three high supporting structures developed from high columns.

FIG. 2A is a perspective view of a building above land with low columns supporting it for tall vegetation to grow over it (tall vegetation is not shown).

FIG. 2B is a back view of the building above land illustrated in FIG. 2A under the branches of tall vegetation.

FIG. 2C is a perspective view of a low supporting structure developed from low columns.

FIG. 3A is a side view of a building above land, part under the branches of tall vegetation and part above short vegetation, with low columns and high columns supporting it.

FIG. 3B is a top view of the building above land shown in FIG. 3A, part under the branches of tall vegetation and part above short vegetation.

FIG. 3C is a perspective view of a supporting structure that is a combination of a low supporting structure and a high supporting structure.

FIG. 3D is a side view of a building above land, part under the branches of extra tall vegetation and part above short vegetation, with low columns and high columns supporting it.

FIG. 3E is a top view of the building above land shown in FIG. 3D, part under the branches of extra tall vegetation and part above short vegetation.

FIG. 3F is a side view of a building, part on land and part above land for vegetation with the support of high columns.

FIG. 4A is a perspective view of a building above land with a supporting-greenhouse supporting it.

FIG. 4B is a perspective view of a supporting greenhouse.

FIG. 4C is a top view of closable screen vents installed on the sunny side and sunless side between the building and the supporting-greenhouse illustrated in FIG. 4A.

FIG. 4D is a side view of a building above land with low columns and a supporting-greenhouse supporting it for tall vegetation and short vegetation.

FIG. 4E is a side view of a building above land with low columns and a supporting-greenhouse supporting it for extra tall vegetation and short vegetation.

FIG. 5A is a perspective view of a section of a road above land with footers, low piers, and beams supporting it.

FIG. 5B is a cross-sectional view of the section of the road shown in FIG. 5A under the branches of tall vegetation.

FIG. 5C is a top view of the section of the road illustrated in FIG. 5A under the branches of tall vegetation.

FIG. 5D is a perspective view of a section of a road above land with footers, high piers, and beams supporting it for short vegetation.

FIG. 6 is a perspective view of a building above land with the support of a supporting-greenhouse developed from a beam structure.

### DRAWINGS—REFERENCE NUMERALS

12 land
16A tall vegetation
16B short vegetation
16C extra tall vegetation
18A building above land and vegetation
18B building above land and under the branches of vegetation
18C building above land, part above shorter vegetation and part under the branches of taller vegetation
18D building above land, part above shorter vegetation and part under the branches of extra tall vegetation
18E building partially above land
18F building above land supported with a beam structure
20 window
22 skylight
23A stairs
23B steps
24A road above land with low supports
24B road above land with high supports
26A high column having pile foundation 26B low column having pile foundation
26C high column
26D high pier
26E low pier
30 footing
30′ footer for low pier
30″ footer for high pier
31 foundation
32 slab
34 beam
34″ beam having underground portion 34″ beam for road
46 window frame
48 glass
49 floor of building
50A closeable screen vent on sunny side
50B closeable screen vent on sunless side
52A shed-shaped high supporting structure
52B frame-shaped high supporting structure
52C low supporting structure
52D a combination of a low supporting structure and a high supporting structure
53 opening for stairs
54A supporting-greenhouse developed from high columns
54B supporting-greenhouse supporting a higher part of a building above land
54C supporting-greenhouse supporting a part of a building
54D supporting-greenhouse developed for beams
55 underground part of a building

### DETAILED DESCRIPTION OF THE INVENTION

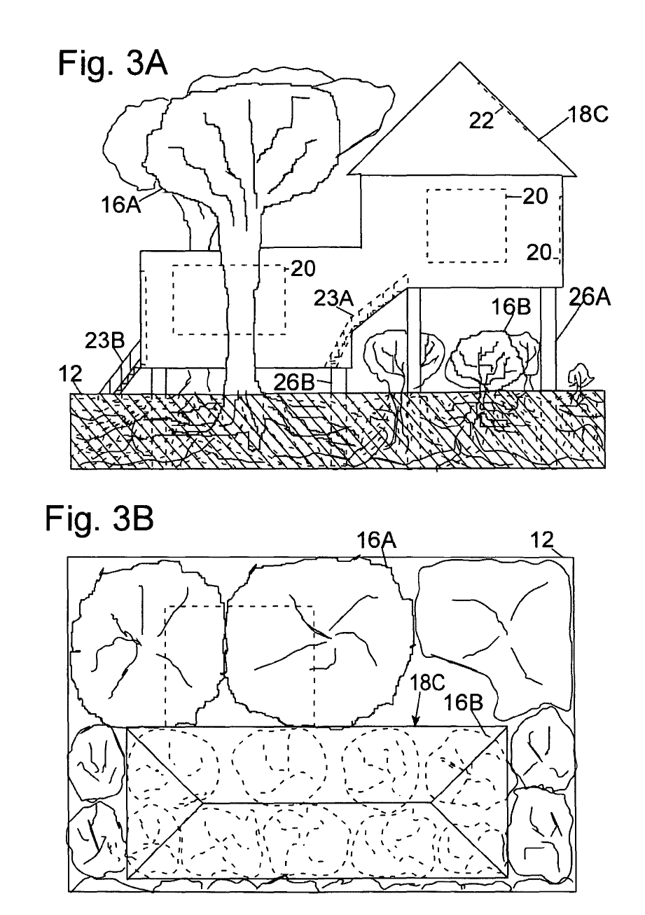

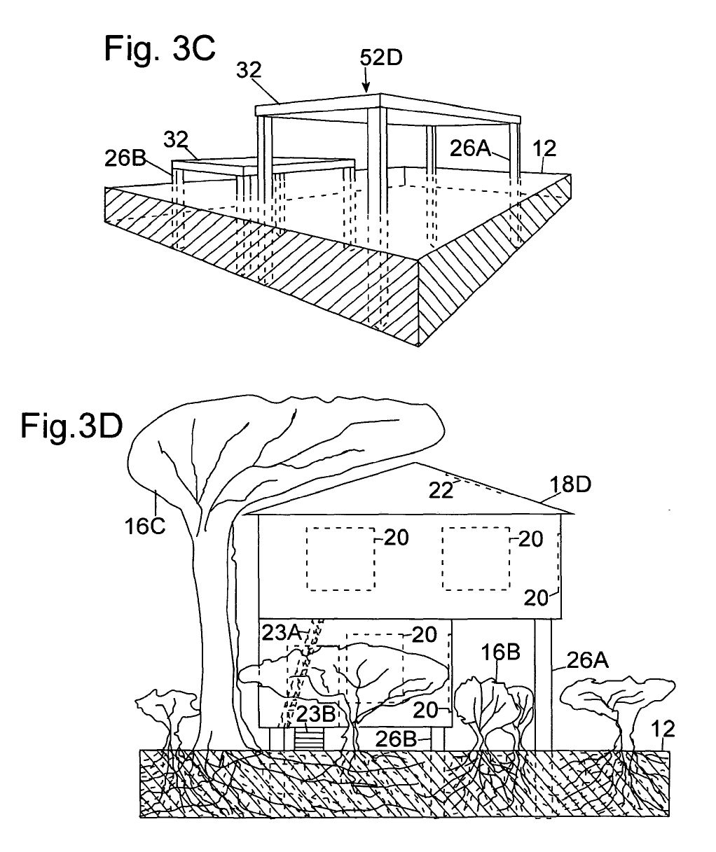

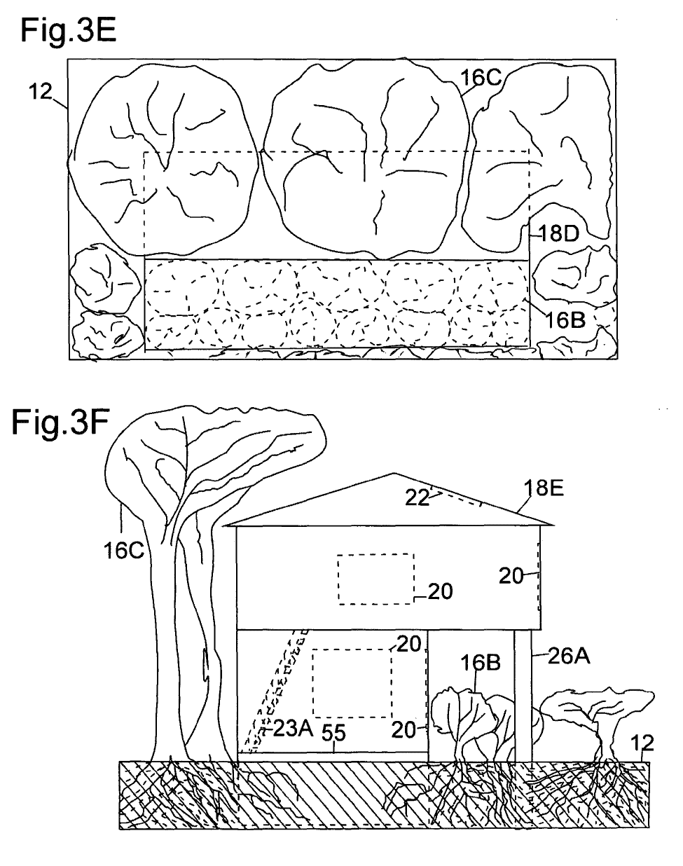

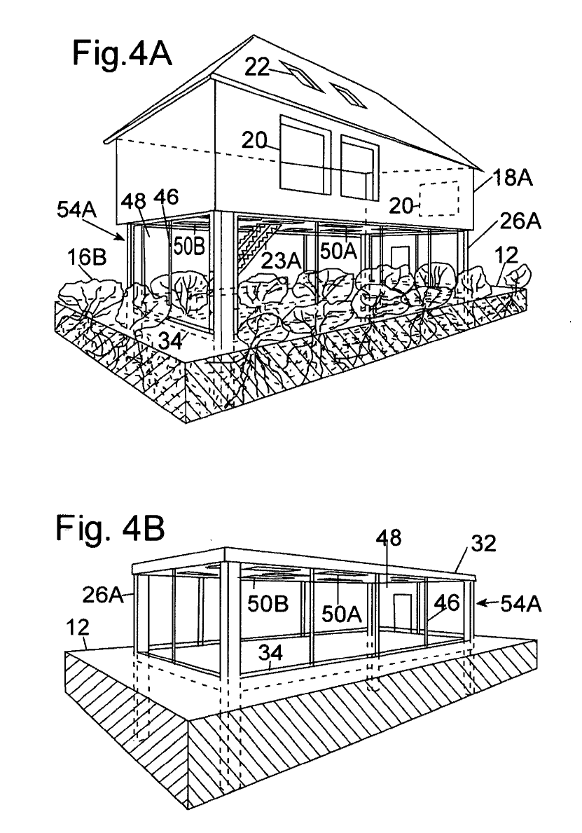

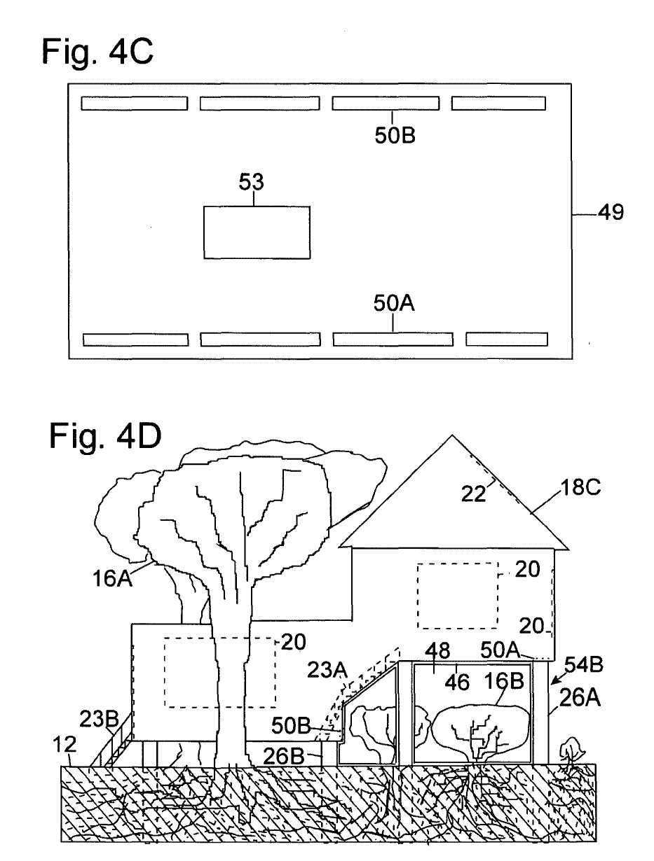

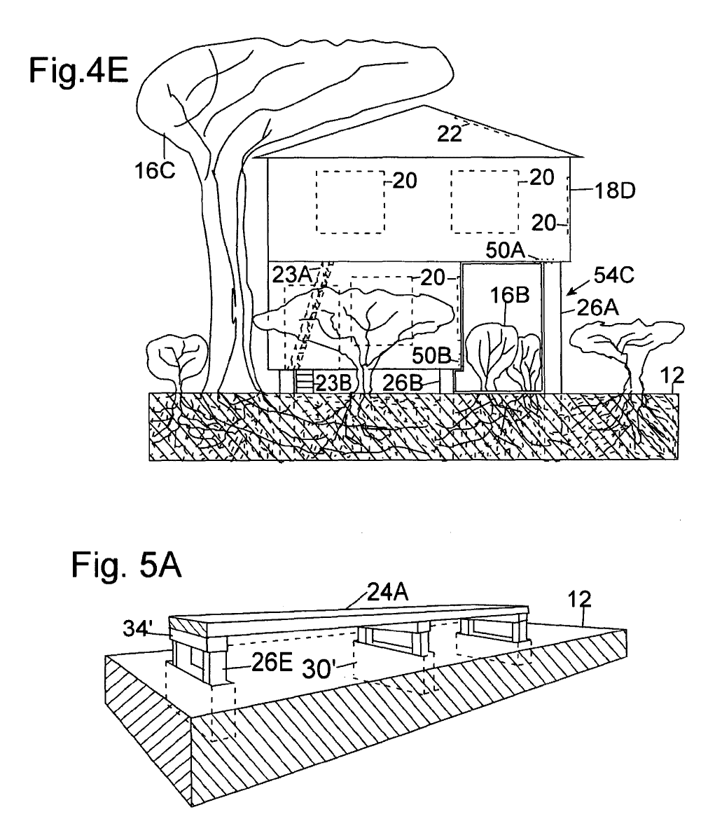

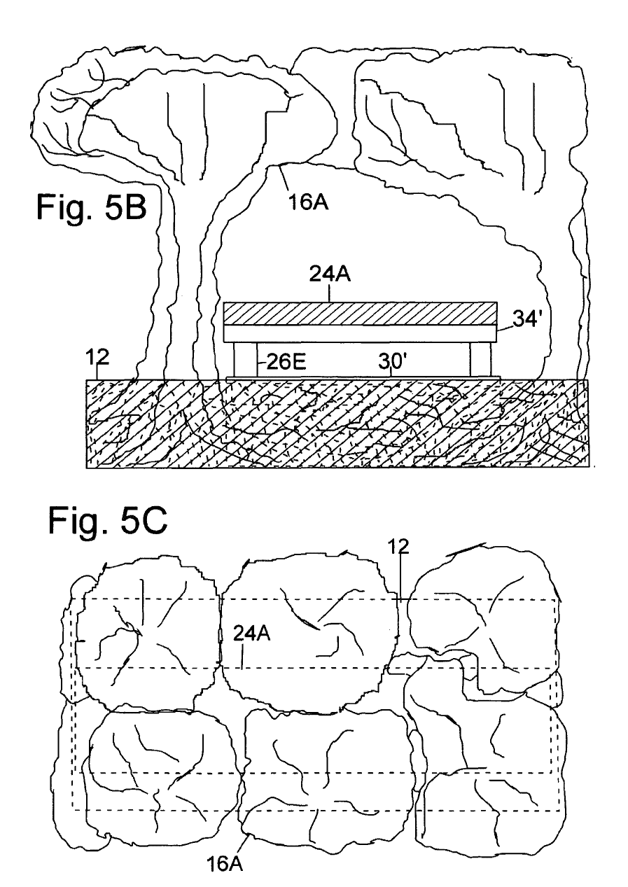

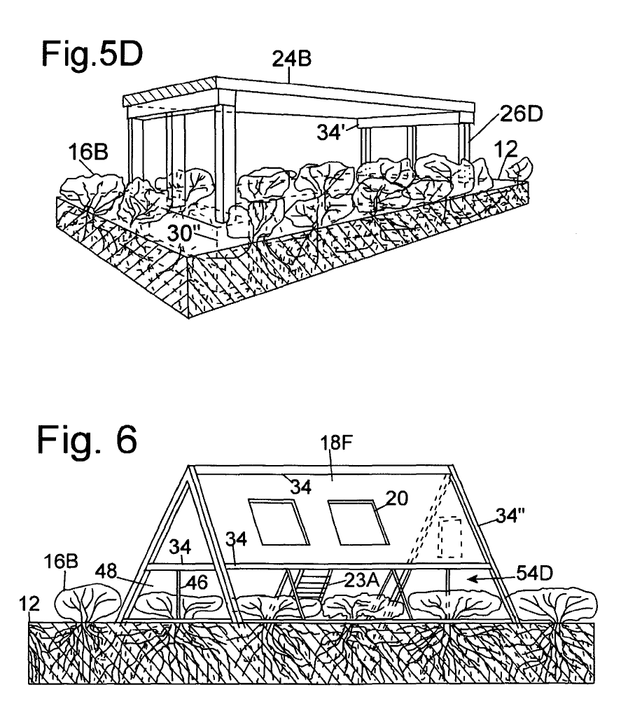

Several embodiments are disclosed herein. Every embodiment features supports, such as columns or beams which support buildings elevated above ground thereby permitting growth of vegetation below the buildings. Supports can be constructed from steel-reinforced molded concrete which are preferred. Alternatively timber or other suitable materials can be used. The terms elevated and elevation refer to the distance above ground that a building is raised. A section of a building elevated to a certain height therefore refers to a section of a building or a part of the building elevated above ground such that exterior space of the same height is below the floor level of the section. In this context, for example, an elevated section cannot refer to the second story of a two story building. A building with two sections elevated to different heights therefore describes a building with a low part and a high part as in FIGS. 3A, 3D, and 3F. The terms elevated and elevation can also refer to a distance above ground of a building constructed above a greenhouse as in FIG. 6. Sections of a building elevated to certain respective heights above ground can also refer to a to sections of a building or a parts of a building elevated above a greenhouse as in FIGS. 4A, 4D, and 4E.

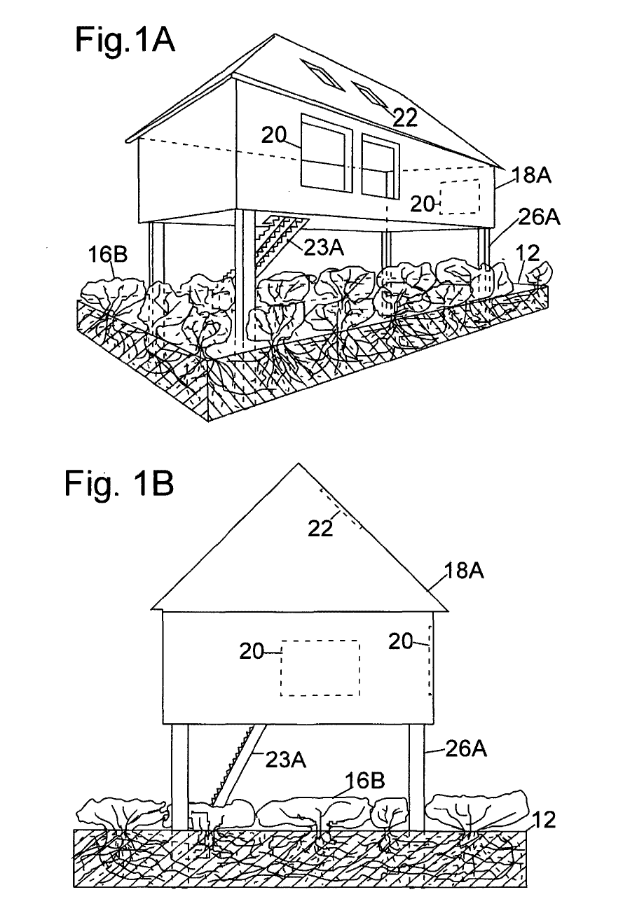

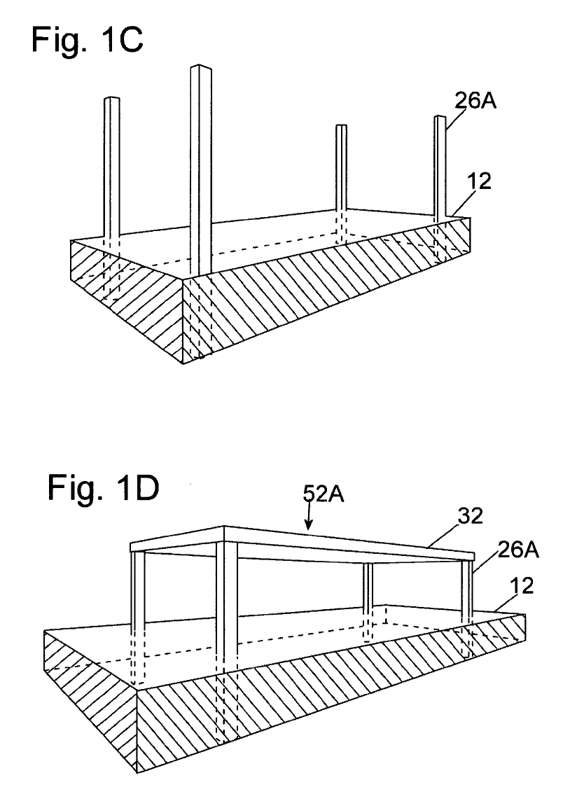

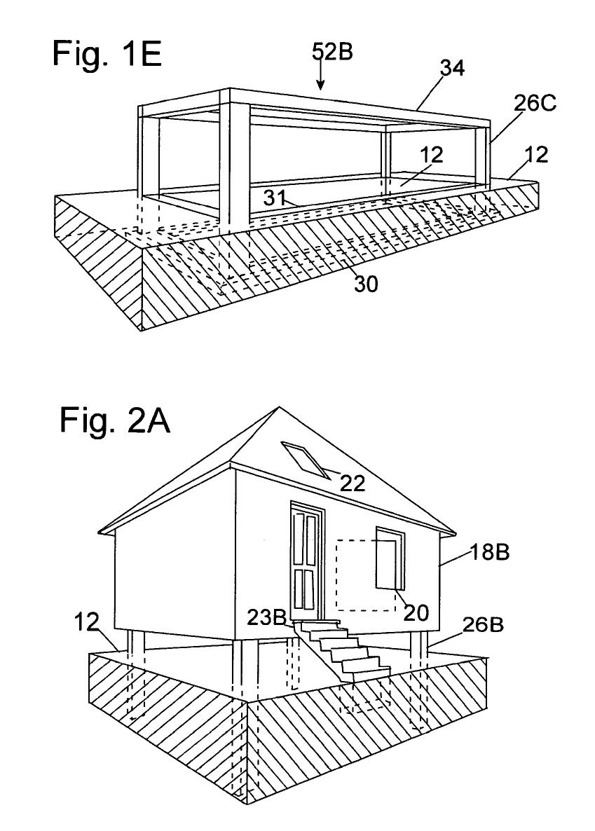

An embodiment of the building-above-land is depicted in FIG. 1A. (perspective view) and FIG. 1B (side view). The building is supported by high columns 26A which are vertically driven into land 12 in certain depth for foundation. Normally, columns 26A and columns used in similar embodiments are driven deeply to refusal or resistance. Because the drawings are not to scale, they do not accurately show the depths to which the columns are driven. The height of elevation above ground is limited by the length of the portions of the columns 26A which remain above ground. The building should be elevated to a height sufficient to permit adequate sunlight to support growth of the vegetation below the building. Low fruit trees, vegetables, and bushes are some of the plants that may be selected for cultivation. Nevertheless, the building can be constructed to accommodate even tall trees growing below, though frequent trimming may be necessary.

The number and size of high columns 26A can vary depending upon the dimensions of the building, building codes, elevation height, and other factors. Horizontal dimensions of the building can be configured to ensure adequate sunlight for vegetation below the building without requiring the building to be elevated to an unreasonable height. In order to ensure adequate year-round sunlight for vegetation, a rectangular building with length oriented along an east-west direction requires higher elevation than a similarly configured building aligned in a north-south direction. The stairs 23A should be positioned to maximize exposure of vegetation to sunlight.

If the building is a family house or small building, windows 20 may be installed only on the eastern side and the most sunlight exposed side (sunny side). Skylights 22 can improve ventilation when there are no windows installed on the western side and sunless side. In this manner windows of adjacent buildings need not face each other for the benefit of privacy of the occupants. Building 18A can be constructed as a multi-storey or high-rise building.

FIG. 1C is a perspective view of four high columns 26A that support building 18A illustrated in FIG. 1A. Columns can be developed into various supporting structures.

FIG. 1D is a perspective view of high supporting structure 52A which is developed from high columns 26A shown in FIG. 1C with slab 32 horizontally connected to their tops. The horizontal dimensions of slab 32 can be longer or shorter than their corresponding dimensions of a building located on it as long as building codes are obeyed and vegetation can get sufficient sunlight to grow on land 12 under slab 32.

FIG. 1E is a perspective view of another high supporting structure 52B. High columns 26C have replaced high columns 26A illustrated in FIGS. 1C and 1D. High columns 26C are different from high columns 26A and based on foundation 31 and footing 30 constructed underground on land 12. High columns 26C and four horizontal beams 34 that have replaced slab 32 illustrated in FIG. 1D constitute frame-shaped high supporting structure 52B. Different from conventional foundations, foundation 31 and footing 30 retain the soil of land 12 for vegetation. The soil of land 12 can be deepened and improved to compensate for the portion of land 12 used for foundation 31 and footing 30.

Space under footing 30 and foundation 31 is available for constructing basement as long as the top layer of land 12 is deep enough for the roots of vegetation.

Supporting structures are not limited to these three embodiments. The foundations of columns and supporting structures can be designed variously as long as sufficient soil is reserved for vegetation and building codes are obeyed. The above ground structures of columns and supporting structures can also be designed differently as long as sufficient space and sunlight are ensured to vegetation and building codes are obeyed. A supporting structure can also be designed to support a number of buildings and other architectural structures as long as building codes are obeyed and the land under the supporting structure is reserved for vegetation.

One critical function of land is its vegetation nurturing function. One critical function of vegetation is its solar-energy-transforming function. The most critical function of building-above-land is retaining the critical functions of both land and vegetation. All vegetation growing on the surface of the earth composes the solar system of the earth, the root of human life. Building-above-land of this invention is to protect the root of human life.

Columns play a key role in building-above-land of this invention to support a building above a plot of land and reserve the land for vegetation and the solar system of earth. Columns can be developed into various supporting structures and supporting-greenhouses. Substitutes such as piles, piers, and beams are also available. Supporting-greenhouses can be developed from high columns, high supporting structures, and other high supports.

As shown in FIG. 1A, the underground portions of high columns 26A work as piles and retain soil for vegetation. The above ground portions of high columns 26A directly support building 18A above land 12 and ensure space and sunlight to low vegetation 16B. Building 18A provides horizontal reinforcement to sustain high columns 26A against the horizontal forces such as wind and seismic forces. This kind of pile foundation can protect and reserve land 12 well for vegetation. However, the cost is high. [0126] As shown in FIG. 1D, land 12 supports high columns 26A, and high columns 26A support slab 32. Slab 32 provides horizontal reinforcement to supporting structure 52A and will directly carries a building above land 12. One horizontal dimension of slab 32 can be adjusted to certain length to reduce the height of supporting structure 52A. The other horizontal dimension of slab 32 can be extended to increase square feet.

A building located on slab 32 is separated from moisture in land 12. Also access to the bottom of the building becomes easy. So, maintenance, update, remodel, and relocation of the building above land become easy. That will be helpful for people to update and remodel their buildings at their locations instead of moving away for new models and increasing commuting distances.

As shown in FIG. 1E, foundation 31 and underground portions of columns 26C join together to provide a support to the above ground part of structure 52B and retain soil for vegetation. Footing 30 disperses the weight of supporting structure 52B and its load. Foundation 31 also protects the soil surrounded by foundation 31. In cold areas and cold season, foundation 31 can help to keep the soil at a necessary temperature with supporting-greenhouse which will be discussed later. Beams 34 provide horizontal reinforcement against the horizontal forces and will directly carry a building above land 12. Supporting structure 52B uses more land than supporting structure 52A shown in FIG. 1D. Fortunately, deepening and improving the soil of land 12 can compensate for the portion of land 12 for foundation 31 and footing 30. One advantage is that foundation 31 and footing 30 cost less than the foundation of supporting structure 52A shown in FIG. 1D.

All embodiments of supporting structure discussed above have two basic functions: supporting a building above land and reserving the land for vegetation. The land can keep its natural function to nurture vegetation, and vegetation can work on the land to transform solar energy and produce fresh air, vegetables, fruits, crops, and flowers for us. Therefore, related shopping, trading, packaging, transportation, refrigeration, energy consumption and pollution can be reduced. Vegetation also absorbs heat, reduces global warming, adjusts climate, cleans atmosphere, reduces pollution, conserves water and provides healthy natural surroundings that are good for health, work, living, exercise, hobby, leisure time, education and peace. A healthy and pleasant natural environment at home let residents, especially children to access and love land, vegetation, fresh air, wild life, and other products of nature and/or god.

Columns can cost no more than a conventional foundation of a building on land and supporting structures are also financially affordable. What they protect is the solar system of earth, the root of human life, and the design of Mother Nature. These embodiments of this invention illustrate how to apply existing architectural technology to embody the values and retain the functions of the products of Mother Nature. When natural environment, nice buildings, and peaceful neighborhood are available in cities, people do not need to live out of town and tolerate long commuting distances. Consequently, reduced traffic will reduce pollution, health problems, global warming, traffic accidents, energy problems, budget, and waste of time. When land keeps nurturing vegetation and sufficient vegetation can work for us, jobs violating the design of Mother Nature can be reduced and leisure time will increase. Enjoyable and significant jobs in line with the design of Mother Nature can also increase. On the contrary, when less and less land and vegetation work for us, and the solar system of the earth is damaged, endless environmental problems, health problems, social problems, and unnecessary painful and destructive jobs inevitably drive us crazy, since we violate the design and reject the blessing of Mother Nature.

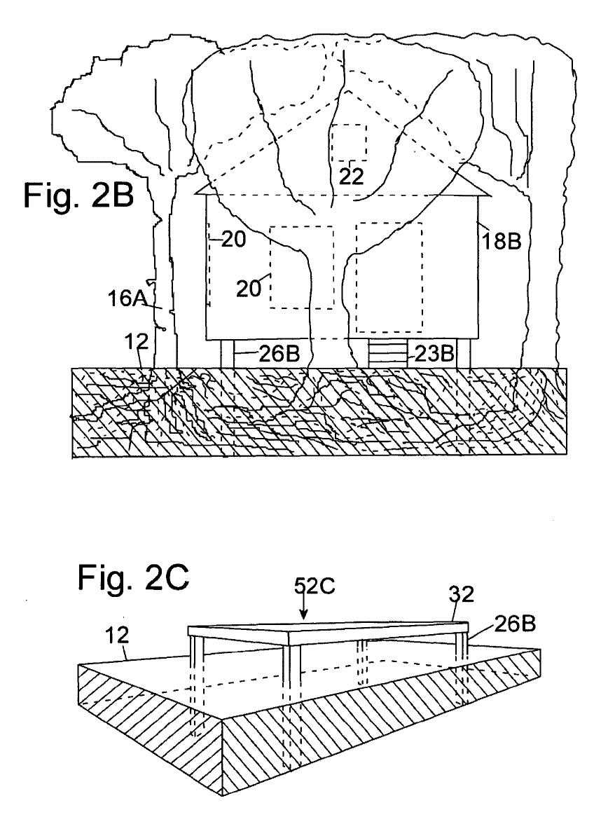

### FIGS. 2A-4C

### Alternative Embodiments

Another embodiment of building-above-land of the present invention is illustrated in FIG. 2A (perspective view without vegetation) and FIG. 2B (back view including vegetation). The underground portions of low columns 26B are vertically driven into land 12 in certain depth for foundation. The portions of low columns 26B remaining on land 12 are low to position building 18B above land 12 but under the branches of tall vegetation 16A. Reasonable trim applied to tall vegetation 16A can increase space for building 18B and help the growth of tall vegetation 16A. Some weak and unhealthy vegetation can be removed from crowded forests for spaces of building 18B and health of tall vegetation 16A. The premise is that the branches of tall vegetation 16A are sufficient to cover building 18B and transform sunlight shinning down on land 12. Low columns 26B and steps 23B also provide as easy access to building 18B as to a building on land. Fences can be installed between low columns 26B for security purpose. [0132] One horizontal dimension of building 18B can be limited to certain acceptable length for the branches of tall vegetation 16A to cover building 18B. Another horizontal dimension of building 18B can be used to increase the square feet of building 18B. Building 18B cannot be very high since its height is limited by tall vegetation 16A. However, for most family houses, spaces under the branches of tall vegetation are high enough. Extra tall vegetation provides more spaces than tall vegetation and the portions of low columns 26B remaining on land 12 can be high enough for low vegetation such as mushrooms and grass to grow on land 12 under building 18B.

FIG. 2C shows low supporting structure 52C that can be used to support building 18B illustrated in FIGS. 2A and 2B. All high supporting structures have their corresponding low supporting structures. Different from high columns, high supporting structures, and supporting-greenhouses, low columns and low supporting structures are mainly used to reserve land for tall and extra tall vegetation and forests. Low columns and low supporting structures also provide easy access to buildings above land.

Another alternative embodiment of building-above-land of this invention is illustrated in FIG. 3A (side view). A combination of low columns 26B and high columns 26A supports building 18e. Low columns 26B position the low part of building 18C under the branches of tall vegetation 16A, and high columns 26A support the high part of building 18C for low vegetation 16B to get sufficient sunlight and space to grow under the high part of building 18e. As shown in FIG. 3B, the branches of tall vegetation 16A cover the low part of building 18C and low vegetation 16B grows under the high part of building 18e. Therefore, land 12 is well covered by vegetation and solar energy on land 12 can be well used by vegetation 16B and 16A, while building 18C can get good shine and be easy of access. FIG. 3C shows supporting structure 52D that is a combination of a low supporting structure and a high supporting structure to support a building like building 18C shown in FIG. 3A and FIG. 3B. A number of supporting structures can also be combined together as long as they are not in the way of each other for sunlight.

Another alternative embodiment of building-above-land of the present invention is shown in FIG. 3D (side view) and FIG. 3E (top view). This embodiment is similar to the embodiment shown in FIG. 3A and FIG. 3B. The difference is that building 18D has more square feet than building 18C shown in FIG. 3A and FIG. 3B since extra tall vegetation 16C provides more spaces under the branches than tall vegetation 16A.

FIG. 3F shows an embodiment that building 18E has only a part supported above land 12 with columns 26A and land 12 has only a part reserved for vegetation 16C and the solar system of the earth. The underground part 55 of building 18E takes a part of land 12 away from vegetation 16e. When a building cannot be totally built above land for certain reasons, this embodiment can be used. The principle of this invention is that the more percentage of a plot of land is reserved for vegetation, the more solar energy can be transformed and deposited by the solar system of the earth, and a little piece of the land reserved for vegetation is better than nothing reserved for vegetation. This embodiment plays the role and reserves a percentage of a plot of land for vegetation and the solar system of the earth.

FIG. 4A shows another alternative embodiment of building-above-land of this invention. Building 18A is based on supporting-greenhouse 54A that is developed from high columns 26A illustrated in FIG. 1e. High columns, high supporting structures, other high supports can be developed into supporting-greenhouses. Four beams 34 are connected to four high columns 26A one by one on or a little under the surface of land 12. Window frames 46 are installed between high columns 26A and between beams 34 and building 18A. Large pieces of glass 48 are installed on window frames 46. Other transparent materials can also be used to substitute for glass 48. Frames 46 can be turned open during hot weather. Between building 18A and supporting-greenhouse 54A, closeable screen vents on sunny side 50A and closeable screen vents on sunless side SOB are installed. Deck can be built inside supporting-greenhouse 54A as long as it is not in the way of sunlight for vegetation.

In cold areas, good insulating glass is recommended for Glass 48. Supporting-greenhouse can be developed from high support structure 52B shown in FIG. 1E, which has foundation. If necessary, foundation slab can be constructed under the foundation. Foundation and foundation slab can keep the soil inside a supporting-greenhouse at certain temperature. Irrigation and drainage systems are installed in supporting-greenhouse 54A. Irrigation and drainage systems can also be installed to other embodiments of this invention. Water used in building 18A can be used to irrigate vegetation growing on land 12 to reduce waste of water. When attention is paid to the water for irrigating own vegetable and fruits, water pollution can be reduced.

In addition to supporting building 18A above land 12 and protecting land 12 for vegetation, supporting-greenhouse 54A increase privacy and make a building above land look like a building on land. That makes building-above-land easy to be accepted by the public. Supporting-greenhouse 54A also brings about an indoor ecosystem and provides oxygen, vegetables, fruits, and flowers.

Supporting-greenhouse 54A works like a special solar energy heater providing warm fresh air and disposing of carbon dioxide. Air inside supporting-greenhouse 54A can be freshened by vegetation and warmed up by sunlight through glass 48. With good insulating glass and building materials, warm fresh air in supporting-greenhouse 54A can be well kept inside and automatically rise up into building 18A through closable screen vents on sunny side 50A. Carbon dioxide in building 18A can sink down into supporting-greenhouse 54A by itself through closable screen vents on sunless side SOB. This way keeps inside warm and fresh, and reduces energy consumption and heating cost. This way can also simplify ventilation, especially for small buildings such as family houses. During night and cold weather, vents 50A and SOB can be closed to keep warm air inside building 18A if vegetation in supporting-greenhouse 54A can accept low temperature. Supporting-greenhouses 54A and other supporting-greenhouses of this invention contribute to the removal of the historical separation between dwellers and natural environment caused by a conventional building on land.

Another important function is that supporting-greenhouse 54A can be built in barren areas and tough climate to increase arable land, vegetation and livable areas on earth. That will extend the solar system of the earth and increase the working season and time of vegetation. That will reduce the pressure of population in many aspects.

FIG. 4B is a perspective view of supporting-greenhouse 54A that supports building 18A illustrated in FIG. 4A. FIG. 4C is a top view of closable screen vents on sunny side 50A and closable screen vents on sunless side SOB installed between supporting-greenhouse 54A and building 18A illustrated in FIGS. 4A and 4B. When building 18A is a high building, supporting-greenhouse 54A should be correspondingly enlarged in order to increase warm fresh air supply and dispose of increased carbon dioxide. Otherwise, supporting greenhouse 54A can only exchange air with some rooms of building 18A. When building 18A is a high building, supporting-greenhouse 54A can supply warm fresh air and dispose of carbon dioxide through ventilation system if necessary.

FIG. 4E shows another embodiment that is developed from the embodiment illustrated in FIG. 3D. This embodiment is similar to the preferred embodiment illustrated in FIG. 4D. Tall vegetation is more than extra tall vegetation and embodiment in FIG. 4D is more practical than the embodiment in FIG. 4E. That is the reason why I select the embodiment illustrated in FIG. 4D as the preferred embodiment of this invention. Furthermore, extra tall vegetation is growing up from tall vegetation. When tall vegetation grows, building 18C illustrated in FIG. 4D can be built up first; when tall vegetation grows up into extra tall vegetation, more rooms can be added and building 18C illustrated in FIG. 4D can be developed into building 18D shown in FIG. 4E. This way can reduce financial pressure on young people when they have no children or have young children.

### FIG. 4D

### Preferred Embodiment

FIG. 4D shows the preferred embodiment of this invention that is developed from the embodiment illustrated in FIG. 3A. High columns 26A in FIG. 3A have been developed into supporting-greenhouse 54B that has the similar functions of 54A illustrated in FIG. 4A. Closable screen vents on sunless side SOB are installed on a position lower than closable screen vents on sunny side 50A. If necessary, supporting-greenhouse 54B can be enlarged to cover more space, supply more warm and fresh air, and dispose of more carbon dioxide.

### FIGS. SA, 5B, 5C, 5D, 6

### Additional Embodiments

Roads and most other architectural structures can also been constructed above ground to reserve land, space, and sunlight for vegetation. Though the cost is high, roads above land are necessary in urban areas to increase vegetation and reduce pollution in cities. The more crowded a city is the more roads, buildings, and other architectural structures need to be constructed above land to increase vegetation and natural environment in cities.

Conventional road materials and construction techniques can be used to construct roads above ground to reserve land, space, sunlight for vegetation. Size and number of footers, piers, beams and other supporting components depend on building codes. When a road above land is constructed under the branches of tall vegetation, the width of a road or a lane should allow the branches of tall vegetation to cover the road or the lane. However, tall vegetation should not bother the view of driving. Highways and other roads for high speed traffic should be constructed above low vegetation for safety purpose and ensure sufficient sunlight to the low vegetation. As long as land can be well reserved for vegetation and roads can be supported above land safely, supporting structures and roads can be designed variously.

Referring now to FIG. 6 is a perspective view of building 18F on supporting-greenhouse 54D that is developed from a beam supporting structure instead of columns. Building 18F can be designed variously as long as it can be supported above land 12 safely for vegetation to get sufficient space and sunlight to grow on land 12 inside and outside supporting-greenhouse 54D. Two vertical A-shaped beam frames are parallel to each other and linked with three horizontal beams 34. Beams 34″ of the two A-shaped beam structures have underground portions in land 12 for foundation. This embodiment shows an example of some other kinds of supports. Supports for buildings above land are not limited to these embodiments as long as they can support a building above land safely and reserve land for vegetation.

### CONCLUSION, RAMIFICATIONS, AND SCOPE

Accordingly, the reader will see that building-above-land of this invention can change the conventional building-on-land and protect the solar system of the earth based on the following possibilities: (a) space and sunlight on the surface of the earth are enough for both buildings and vegetation; (b) buildings are not necessary to be built on land while land is necessary and possible to be reserved for vegetation; (c) a plurality of columns can cost no more than a conventional foundation of a building on land; (d) buildings above land can keep all facilities and conveniences of conventional buildings on land; (e) buildings above land are as easy of access as conventional buildings on land; (f) rooms of buildings above land can get good sunshine; (g) supporting-greenhouses make buildings above land look like buildings on land and easy to be accepted by the public; (h) supporting-greenhouses retain privacy and provide indoor ecosystems for families and working places.

Building-above-land of this invention is a flexible way to share land and space with all species of vegetation with different heights. Columns, supporting structures, and other supports can position buildings: (a) above land and vegetation to protect farmland and short vegetation; (b) under branches of tall and extra tall vegetation to protect forests and tall and extra tall vegetation; (c) part above short vegetation and part under the branches of tall and extra tall vegetation. Farmland and forests can remain in their state during construction and reserved in cities. Various plants of different heights can grow on land naturally instead of on walls or on roofs artificially and expensively.

Building-above-land of this invention can reserve land for vegetation on a large scale with great speed. When millions and millions of people and thousands and thousands of builders realize the benefits and possibilities of building-above-land for vegetation, the conventional destructive building-on-land can stop and building-above-land for vegetation can restore vegetation worldwide.

Building-above-land for vegetation also makes maintaining, remodeling, updating, and relocating a building easy. People do not need to move far away and tolerate long commuting distances for new models and natural environment. Supporting-greenhouses also further provide indoor ecosystem and remove the conventional separation between dwellers and natural environment.

Building-above-land of this invention provides a new way to use land and develop a city. Groups of columns, piers, supporting structures, and supporting-greenhouses can be constructed and pre-located in certain areas according to plans for buildings and roads built on them later. Those columns, piers, supporting structures, and supporting-greenhouses themselves can present new and beautiful landscapes with different architectural designs.

Land has been occupied and sealed by buildings and roads in urban areas can also been restored to vegetation. The above embodiments can be referred to for restoring land under buildings and roads to vegetation and the solar system of the earth. No downtown areas should be deserted and keep taking land away from vegetation and the solar system of the earth. Farmland, gardens, forests, and natural environment can be well reserved in cities.

The reader can see that building-above-land of this invention is economical, practical, and significant, and millions and millions of acres of land can be reserved for the solar system of the earth to reduce global warming. Mankind can enjoy the design and blessing of Mother Nature in a right way.

There are a multitude of advantages that derive from building above land, including but not limited to the following:

It provides a solution to the historical conflict between buildings and vegetation.

It protects the root of human life, vegetation and the solar system of the earth that do so many great things for us: (a) supplying energy, oxygen, and natural environment; (b) absorbing heat, reducing global warming, and adjusting climate; (c) cleaning the atmosphere, reducing pollution, and conserving water.

It provides a way to produce fresh vegetables, fruits, and flowers under a building, and reduce shopping, trading, packaging, transportation, refrigeration, energy consumption, and pollution.

It provides a way to reserve and increase natural surroundings for work, living, exercise, hobby, leisure time, and health.

It provides a way to develop cities and keep natural environment in cities.

It provides a way to reduce temperature in cities and cut expenditure on air conditioning.

It provides convenience for people to maintain, remodel, update and even relocate houses and buildings.

It increases arable land, vegetation and livable areas in barren areas.

It provides supporting-greenhouses which improve indoor air quality and reduce indoor heating costs.

It provides a way to reduce natural disasters.

The embodiments described above illustrate many aspects of the invention. These embodiments should not be construed as limiting the scope of the invention but as merely illustrations which are within the scope of the invention. It thus will be appreciated that those skilled in the art will be able to devise numerous alternative arrangements that, while not shown or described herein, embody the principles of the invention and thus are within its spirit and scope.

I claim:

1. A method of preserving or restoring a section of land in need of preservation or restoration comprising,
building an elevated house above said land area in need of preservation or restoration, wherein said house is elevated to a height sufficient to allow for sustaining of vegetation below said house, and
cultivation of vegetation below said house, thereby making an eco-friendly human habitation environment.

2. The method according to claim 1 further comprising,
constructing said elevated house above said land area, said elevated house having sections, wherein said elevated house is elevated by means of said sections wherein said sections are elevated to different heights above said land area.

3. The method according to claim 1 further comprising,
constructing said elevated house above a greenhouse, said greenhouse located directly below said elevated house, said greenhouse having transparent walls or translucent walls.

4. The method according to claim 1 further comprising,
building said elevated house with supporting beams, and arranging said supporting beams to form said elevated house with an A-frame structure, said supporting beams extending from apex of said A-frame structure to said land.

5. The method according to claim 4 further comprising,
constructing said elevated house above a greenhouse, said greenhouse located directly below said elevated house, said greenhouse having transparent walls or translucent walls.

6. A building designed for environmental preservation or restoration of land, comprising
a building elevated above land, wherein said land is capable of supporting cultivation of shrubs and other vegetation below said building,

7. The building according to claim 6 further comprising,
at least one section of said building wherein said section is elevated to a height which would enable sufficient sunlight to support viability of said shrubs and other vegetation,
two or more sections elevated by at least two different heights above land wherein said house elevated above land is elevated to the at least two different vertical heights above a fixed point on said land.

8. The building according to claim 7 further comprising,
a greenhouse located directly below said building,
said greenhouse having transparent walls or translucent walls.

9. The building according to claim 6 further comprising,
a greenhouse located directly below said building,
said greenhouse having transparent walls or translucent walls.

9. The building according to claim 6 further comprising,
an A-frame structure,
said A-frame constructed from supporting beams,
said supporting beams being of sufficient length to elevate said building to a height sufficient to support viability of cultivated shrubs and other vegetation.

10. A building comprising,
a building elevated above a section of land,
a greenhouse located below said building, and
transparent or translucent walls, said greenhouse having said transparent or translucent walls.

11. The building according to claim 10, further comprising,
an A-frame structure,
said A-frame constructed from supporting beams.

12. The building according to claim 11, further comprising,
supporting beams, said A-frame constructed from supporting beams, said supporting beams being of sufficient length to elevate said building to a height sufficient to support viability of cultivated shrubs and other vegetation within said greenhouse.
